(19) United States
(12) Patent Application Publication
(10) Pub. No.: US 2015/0127375 A1
(43) Pub. Date: May 7, 2015

(54) METHODS AND SYSTEMS FOR CLOUD-BASED MEDICAL DATABASE MANAGEMENT

(71) Applicants: TA-HSIUNG HU, Taipei City (TW); YIH-SHIOU HWANG, (US); TZU-CHEN YEN, Taipei City (TW)

(72) Inventors: YIH-SHIOU HWANG, New Taipei City (TW); TZU-CHEN YEN, Taipei City (TW); TA-HSIUNG HU, Taipei City (TW)

(21) Appl. No.: 14/070,447

(22) Filed: Nov. 1, 2013

(51) Int. Cl. G06Q 50/24; G06F 19/00

(52) U.S. Cl. CPC G06Q 50/24; G06F 19/324
USPC 705/3

(57) ABSTRACT

A method is provided for a user, such as a medical research primary investigator (PI), to manage patient clinical database is configured to allow the primary investigator to build a private clinical database on a cloud-based system in his specific format and structure. The existing clinical data in a database in a hospital information system can be extracted and converted to the new format and new structure and stored in a private database in the cloud-based system. A hospital server is configured to allow the user to enter new clinical data in the new format and stored in the cloud-based private database. The new data is also entered in the existing database in the hospital information system to maintain continuity in the operation of the hospital information system.

### CROSS-REFERENCES TO RELATED APPLICATIONS

This application is related to in U.S. Pat. No. 7,822,976 and U.S. Patent Pub. No. 2012/0203817, the contents of both of which are incorporated herein by reference in their entirety.

### BACKGROUND OF THE INVENTION

The present invention relates generally to database management systems. More particularly, embodiments of the invention provide methods and systems for cloud-based medical database management.

In a hospital or hospital system, clinical parameters/data (such as diagnosis, blood test results, visual acuity, image studies, reports of clinical procedures, medication administered or surgical intervention) are stored digitally in a hospital database. Such database is usually included in an HIS (Hospital Information System or Health Information System). Besides supporting the daily clinical operation of the hospital, medical primary investigators (PI) often access the database to monitor the progress of a patient or to conduct formal clinical studies.

Thus, large amount of clinical data in the database can be analyzed to identify at-risk patients, track clinical outcomes, performance measurement and management, clinical decision making at the point of care, and research on a large scale. However, conventional hospitals data management systems often provide only relatively simple database functions such as health care data retrieval for individual patients.

### BRIEF SUMMARY OF THE INVENTION

The inventors have observed that conventional health care databases have many drawbacks. The conventional hospital computer system may allow the health care providers to access the clinical data stored in HIS, but only in a very limited way. Hospitals or health care organizations continue to struggle with extracting and analyzing the wealth of digital information locked within the existing silos of the hospital systems. For example, the health care provider can only retrieve clinical data for a particular patient, but the database usually is not amenable for in depth clinical data analysis. For example, the system usually does not perform any inter-patient comparison (e.g. the blood pressure of all the patients before and after taking drug x). If the number of patients is large (e. g. >10000), then the data retrieval would be very cumbersome and time consuming. For example, an extensive clinical study may need many assistants and take a long time to retrieve all the data to make an Excel table for further calculation. Thus, there is a need for easy-to-use interfaces with data mining and statistical analysis capability to analyze digital clinical data to improve health care outcome and reduce health care cost.

Embodiments of the present invention provide a cloud-based system to link cloud-based applications to a conventional hospital database. In an embodiment, the cloud-based system provides a method for the user to define a private customized database. The data template and protocol can be tailored for a specific application, for example, a clinical study. The cloud-based system is linked to the hospital database, so that existing or new data in the hospital database can be selected and stored in the user's private database in the cloud. Private databases on multiple cloud-based systems, which can include clinical data from different hospitals or different countries, can be merged for a multicenter study. The cloud-based system can provide on-line database storage and backup of clinical data for a large number of patients. Data analysis, including analysis for clinical studies, can be carried out efficiently and, in some embodiments, automatically. Analysis results can be provided timely and cost-effectively. Furthermore, the cloud-based system allows the user access via different devices, such as windows laptop, iPad, or even mobile smart phones.

According to some embodiments of the present invention, a method is provided for a user, such as a medical research primary investigator (PI), to manage patient clinical database. The method allows the primary investigator to specify and build a private clinical database on a cloud-based system in his specific format and structure. The existing clinical data in a database in a hospital information system can be extracted and converted to the new format and new structure and stored in a private database in the cloud-based system. A hospital server is coupled to the hospital database and is configured to allow the user to enter new clinical data in the new format and stored in the cloud-based private database. In some embodiments, the new data is also entered in the existing database in the hospital information system to maintain continuity in the operation of the hospital information system.

According to an embodiment of the present invention, a method for managing a private database in a cloud-based system includes providing a first database protocol that includes a first data template for a first database structure for a first database provided by a cloud-based system, and entering new data according to the first data template. The new data is entered into the first database in the cloud-based system according the first database protocol, and the new data is into the second database according to a second database structure that is different from first database structure. The method also includes extracting data from the second database according to a selection criterion in the first protocol, wherein the extract data is entered into the first database in the cloud-based system in the first database structure according to the first database template. The method can also include analyzing the data in the first database using the web-based portal provided by cloud-based system.

According to an embodiment of the present invention, a method for a user to manage a private database in a cloud-based system includes specifying a first database protocol that includes a first data template for a first database structure using a web-based portal provided by the cloud-based system, which includes a first database for the user containing data in the first database structure. The first database protocol is entered into a server that is coupled to a second database system that contains data arranged in a second database structure that is different from first database structure, the server being coupled to the cloud-based system by a network connection. New data is entered in the server according to the first data template, wherein the server copies the new data into the first database in the cloud-based system via the internet portal according the first database protocol, and the server enters the new data into the second database according to the second database structure. The method also includes selecting data from the second database according to a selection criterion in the first protocol using the server, wherein the server enters the selected data into the first database in the cloud-based system in the first database structure according to the first database template. The method can also include analyzing data in the first database using the web-based portal provided by the cloud-based system.

In a cloud-based system, a method for a user to manage patient clinical database includes providing a first clinical database protocol that includes a first clinical data template suitable for a clinical study using a web-based portal provided by a cloud-based system, the cloud-based system including a private database configured by and for the primary investigator himself in a first medical database structure. The method includes entering the first clinical database protocol into a hospital server that is coupled by a network connection to the cloud-based system and is also coupled to a hospital information system (HIS). The HIS contains patient medical data arranged in a second medical database structure that is different from first medical database structure, said hospital server being configured to convert patient data between the first and the second medical database structures. The method includes performing one or more of the following tasks.
(i) entering new patient clinical data in the first clinical data template using the hospital server, wherein the hospital server enters the new patient clinical data into the user's private database in the cloud-based system according to the first medical database structure after removing the patient's personal identification information and naming a new protocol ID, wherein the new patient clinical data is entered into the HIS according to the second medical database structures; and
(ii) extracting existing patient clinical data from the HIS for the clinical study according to a selection criterion in the first protocol using the hospital server, wherein the selected patient clinical data is entered into the user's private database in the cloud-based system in the first medical database structure after the patient's personal identification information is removed; and
   The method also includes performing the clinical study using data in the user's private database using the web-based portal provided by the cloud-based system.

A further understanding of the nature and advantages of the present invention may be realized by reference to the remaining portions of the specification and the drawings.

### BRIEF DESCRIPTION OF THE DRAWINGS

FIG. 1 is a simplified block diagram of a cloud-based system that can be used for providing various services according to an embodiment of the present invention;

FIG. 2 is a simplified block diagram of a database management system 200 in which a user can use a cloud-based system to manage a medical database according to another embodiment of the present invention;

FIG. 3 is a flowchart illustrating a method for a user to manage a medical database for clinical study according to another embodiment of the present invention;

FIGS. 4A-4E illustrate an example of clinical data template in a user-defined clinical study protocol according to an embodiment of the present invention;

FIGS. 5A-5D illustrate another example of clinical data template in a user-defined clinical study protocol according to an embodiment of the present invention;

FIG. 6A illustrates a screenshot for initiating a new clinical study protocol using the protocol builder in the cloud-based system according to an embodiment of the present invention;

FIG. 6B illustrates a screenshot of a completed protocol according to an embodiment of the present invention;

FIG. 7 illustrates an example of parameter selection menu provided by the protocol builder according to an embodiment of the present invention;

FIG. 8 is a diagram illustrating an example of database management process flow according to an embodiment to the present invention;

FIG. 9 is a system diagram and flowchart showing the operation of the cloud-based database management system according to an embodiment of the present invention;

FIG. 10 illustrates schematically the combination of clinical data from multiple private cloud-based databases according to an embodiment of the present invention;

FIG. 11 illustrates schematically additional security features for protecting patient's privacy and data security in a merged cloud system according to an embodiment of the present invention;

FIG. 12A to FIG. 12D are screenshots showing the steps to enroll a new patient into a clinical protocol in the cloud-based system according to an embodiment of the present invention.

### DETAILED DESCRIPTION OF THE INVENTION

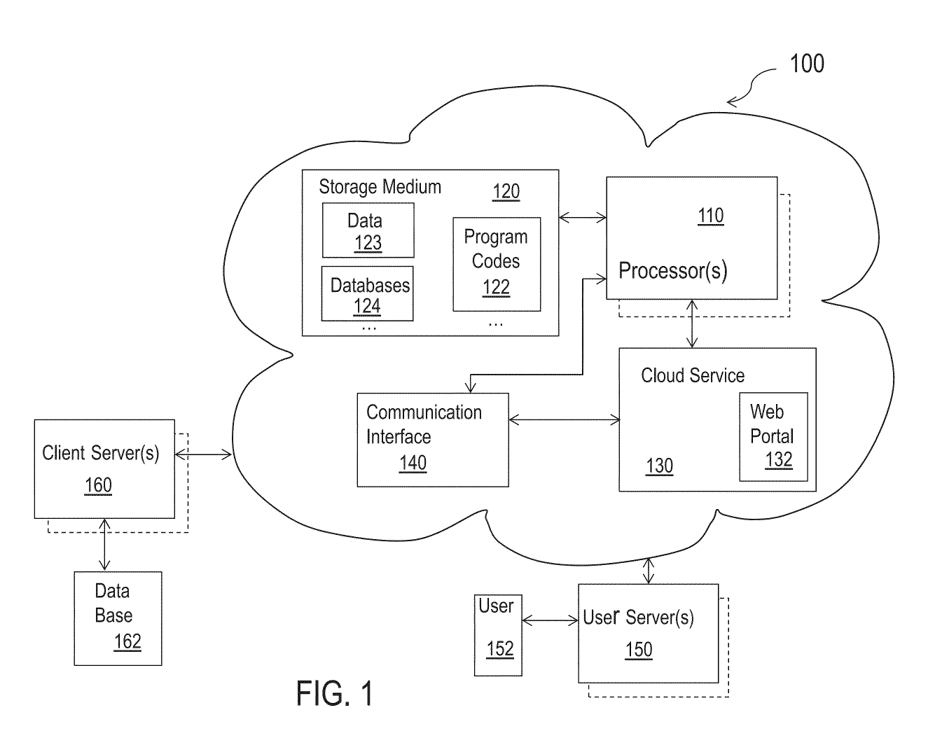

FIG. 1 is a simplified block diagram of a cloud-based system 100 that can be used for providing various medical database management services according to an embodiment of the present invention. As shown, cloud-based system 100 includes one or more processors 110 and a storage medium 120 coupled to the processors 110. Depending on the embodiment, processor 110 may include a single processor, multiple processors, or a number of local or distributed processors operating in parallel. Storage medium 120 can include various memory and mass storage devices, such as DRAM, SRAM, non-volatile memory devices, read only memory (ROM), disk storage, optical CD, DVD, etc. Storage medium 120 are configured to store one or more computer instruction codes 122 and data 123, while processor 110 is configured to retrieve the code and data, and to execute the computer code. In the embodiment of FIG. 1, storage medium 120 can include one or more databases 124.

As shown in FIG. 1, cloud-based system 100 also includes cloud services 130, which may include a cloud platform such as a web-based portal 132. Cloud-based system 100 also includes a communication interface 140 for interfacing with one or more user servers 150 and one or more client servers 160. In some embodiments, a user 152 can access the web-based portal 132 through the user server 150. In some embodiment, client server 160 may connect a database 162 to the cloud-based system 100. The servers can be conventional servers that may include a storage medium, one or more processors coupled to the storage medium, and an interface to a network.

In some embodiments, when computer programmable instructions or codes are retrieved from a storage medium and executed by a processor in the cloud based system and the server, certain database management functions are performed. Some examples are described below.

In some embodiments, computer codes in the cloud-based system, when retrieved from the storage medium and executed by the one or more processors, performs one or more of the following functions:
providing a web portal for a user;
receiving user input for constructing a first database protocol that includes a first data template for a first database structure for a first database provided by the cloud-based system;
receiving data from the network and storing the received data in the first database; and
receiving user command for data analysis.
   In some embodiments, computer codes in the server, when retrieved from the storage medium and executed by the one or more processors, performs one or more of the following functions:
receiving first database protocol that includes the first data template;
receiving new data according to the first data template;
storing the new data is into the second database according to a second database structure that is different from first database structure;
extracting data from the second database according to a selection criterion in the first protocol; and
entering data into the first database in the cloud-based system according the first database protocol.

According to an embodiment of the present invention, a method is provided for a user to manage a private database in a cloud-based system. First, a user provides a first database protocol that includes a first data template for a first database structure for a first database 124 provided by a cloud-based system 100. A server 160 is coupled to a second database system 162 that contains data arranged in a second database structure that is different from first database structure. The server is also coupled to the cloud-based system. The user can enter new data according to the first data template, and the new data is entered into the first database 124 in the cloud-based system according the first database protocol. In some embodiments, the new data is also entered into the second database 160 according to the second database structure. In some embodiments, existing data from the second database is extracted according to a selection criterion in the first protocol. The extract data is entered into the first database 124 in the cloud-based system 100 in the first database structure according to the first database template. The user can analyze the data in the first database 124 using the web-based portal 132 provided by cloud-based system 100. Depending on the embodiments, the user can enter the first database protocol using the web-based portal provided by the cloud-based system or using the server. Similarly, in some embodiments, the user can enter the new data using the web-based portal provided by the cloud-based system or using the server. Further, the data conversion can be performed either by the cloud-based system or the server.

According to another embodiment of the present invention, a method is provided for a user to manage a private database in a cloud-based system. First, a user specifies a first database protocol that includes a first data template for a first database structure using a web-based portal provided by the cloud-based system. The cloud-based system includes a first database 124 for the user that contains data in the first database structure. Then, the first database protocol is provided to server 160 that is coupled to a second database system 162 that contains data arranged in a second database structure that is different from first database structure. In some embodiments, server 160 is configured to convert data between the first and the second database structures. Then, the user can enter new data into server 160 according to the first data template, wherein the server enters the new data into the first database 124 in the cloud-based system according the first database protocol, and the server enters the new data into the second database 160 according to the second database structure. In some embodiments, the server 160 is also configured to select data from the second database according to a selection criterion in the first protocol. The server then enters the selected data into the first database 124 in the cloud-based system 100 in the first database structure according to the first database template. The user can analyze the data in the first database 124 using the web-based portal 132 provided by cloud-based system 100.

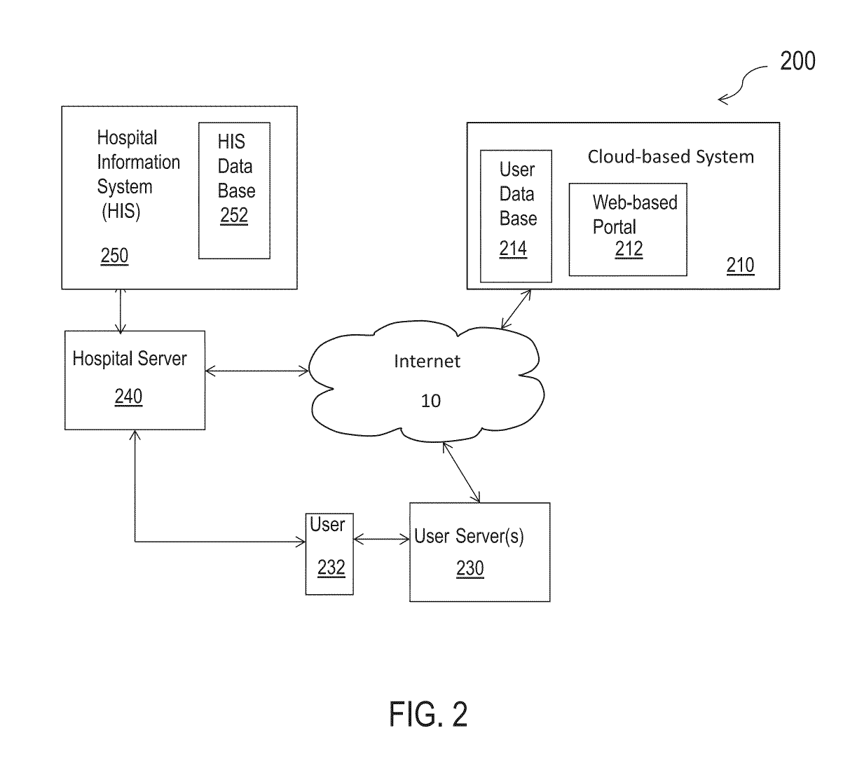

FIG. 2 is a simplified block diagram of a database management system 200 in which a user can manage a medical database according to another embodiment of the present invention. In some embodiment, medical database management system 200 can be used by a medical research primary investigator (PI) to perform a clinical study. As shown in FIG. 2, database management system 200 includes a cloud-based system 210 coupled to a communication network, such as an internet 10. In an embodiment, cloud-based system 100 described above in connection with FIG. 1 can be used as cloud-based system 210 in database management system 200. In this embodiment, cloud-based system 210 includes a web-based portal 212 and a user database 214. Further, cloud-based system 210 can include other components in cloud-based system 100 of FIG. 1 described above.

As shown in FIG. 2, a user server 230 is coupled to the internet 10 to provide access to web-based portal 212 to a user 232, such as the primary investigator (PI). A hospital server 240 is coupled to cloud-based system 210 through internet 10. Hospital server 240 is also coupled to a hospital information system (HIS) 250, which includes a HIS database 252. In some embodiments, the HIS can be part of the hospital intranet system, which may allow authorized users to access the HIS database. In some embodiments, a computer gateway server, which can be part of the hospital intranet system, is used to connect to the internet.

According to some embodiments of the present invention, a method is provided for a user, such as a medical research primary investigator (PI), to manage patient clinical database. The method allows the primary investigator to build a private clinical database on a cloud-based system in his specific format and structure. The existing clinical data in a database in a hospital information system can be extracted and converted to the new format and new structure and stored in a private database in the cloud-based system. A hospital server is configured to allow the user to enter new clinical data in the new format and stored in the cloud-based private database. The new data is also entered in the existing database in the hospital information system to maintain continuity in the operation of the hospital information system.

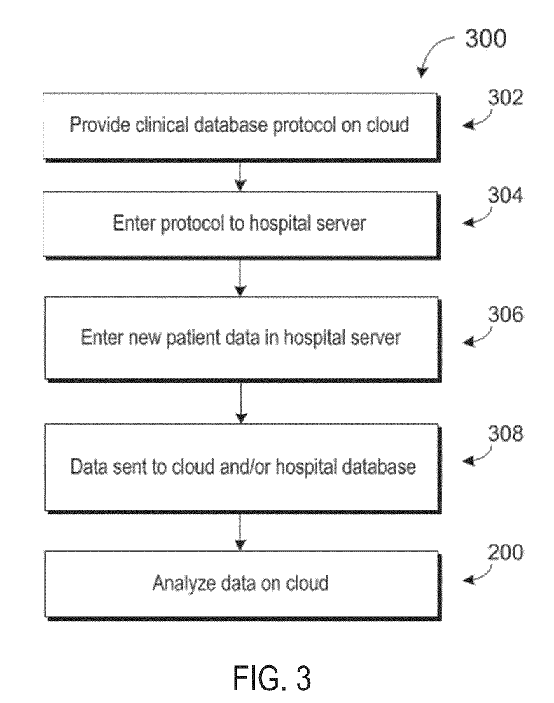

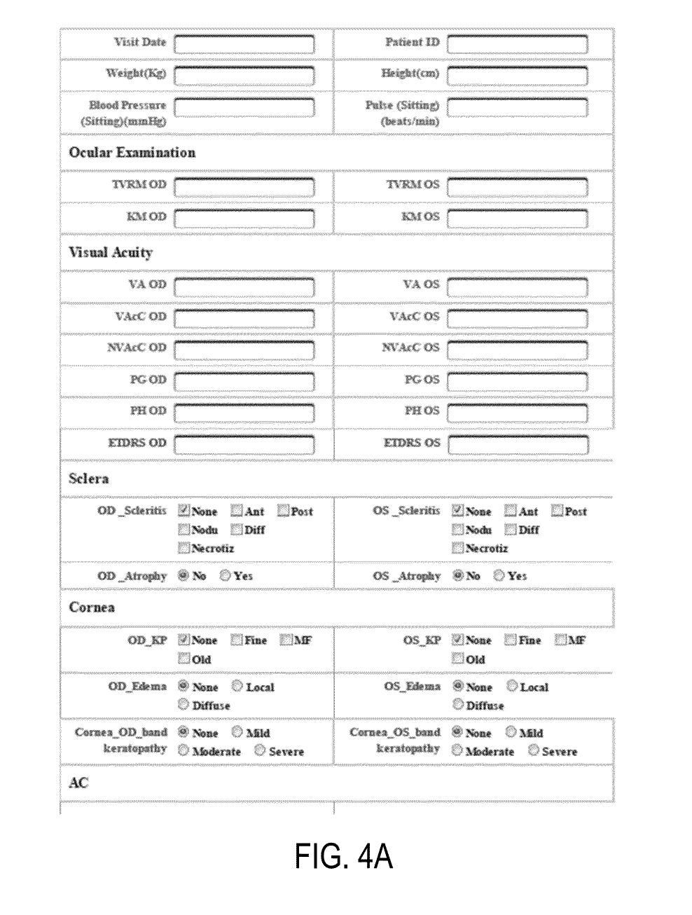

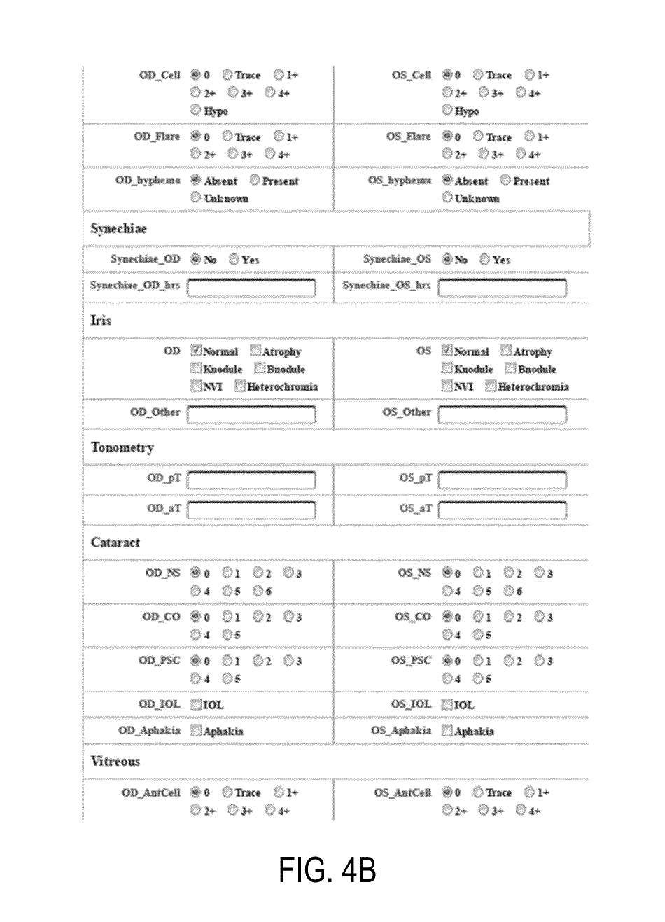

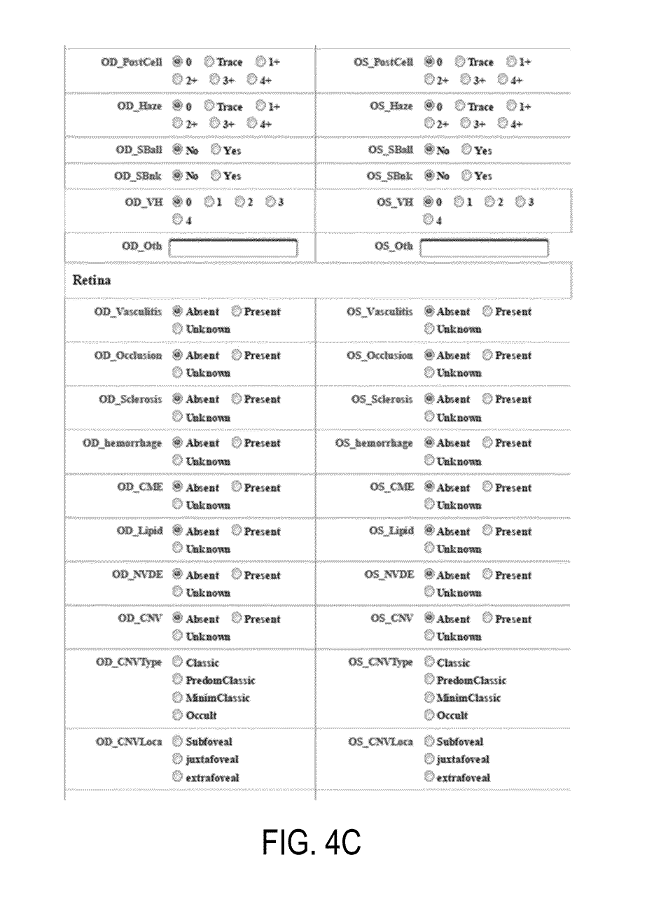

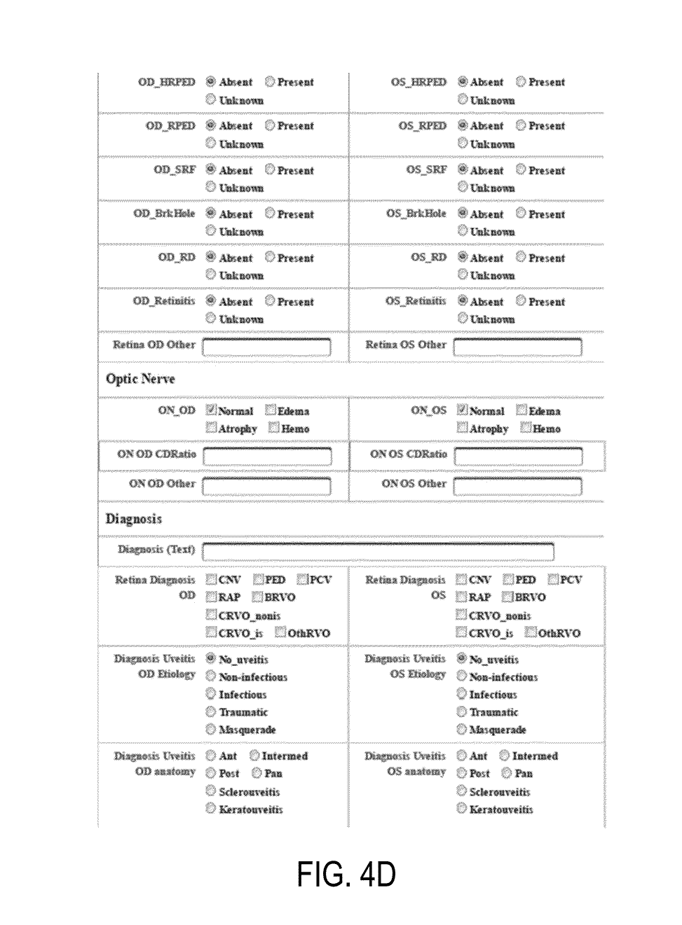

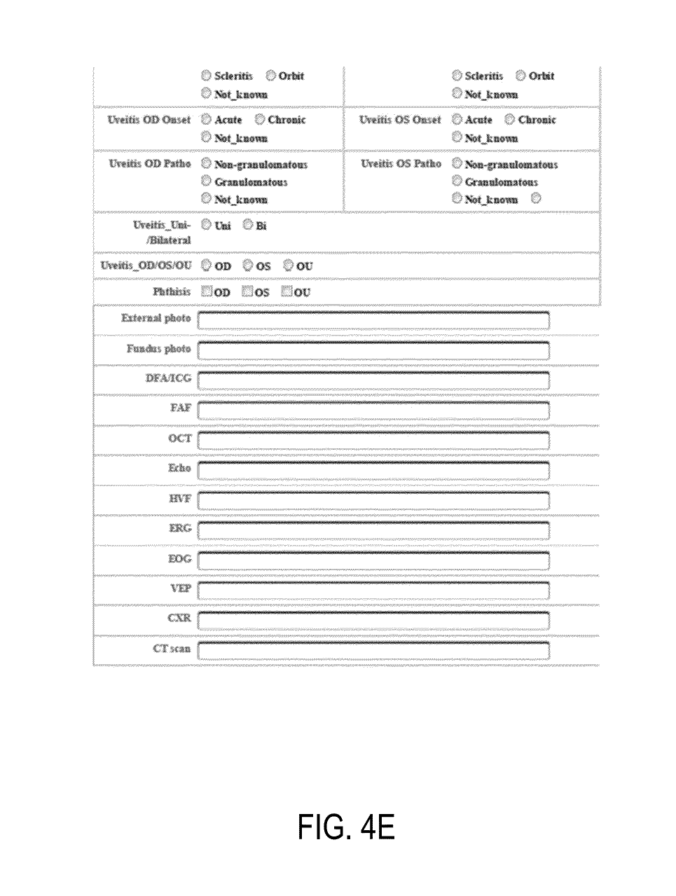

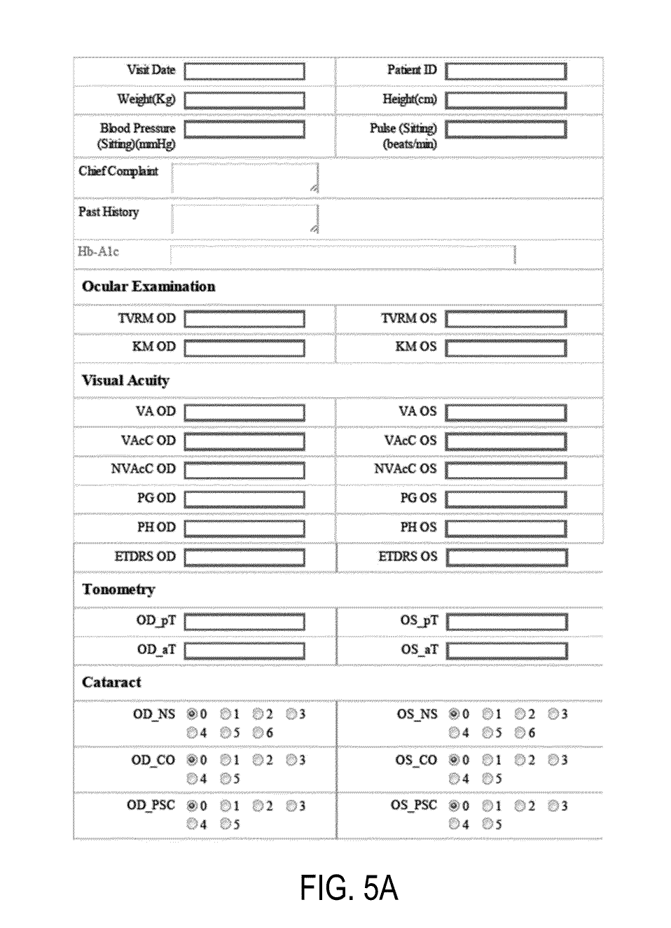

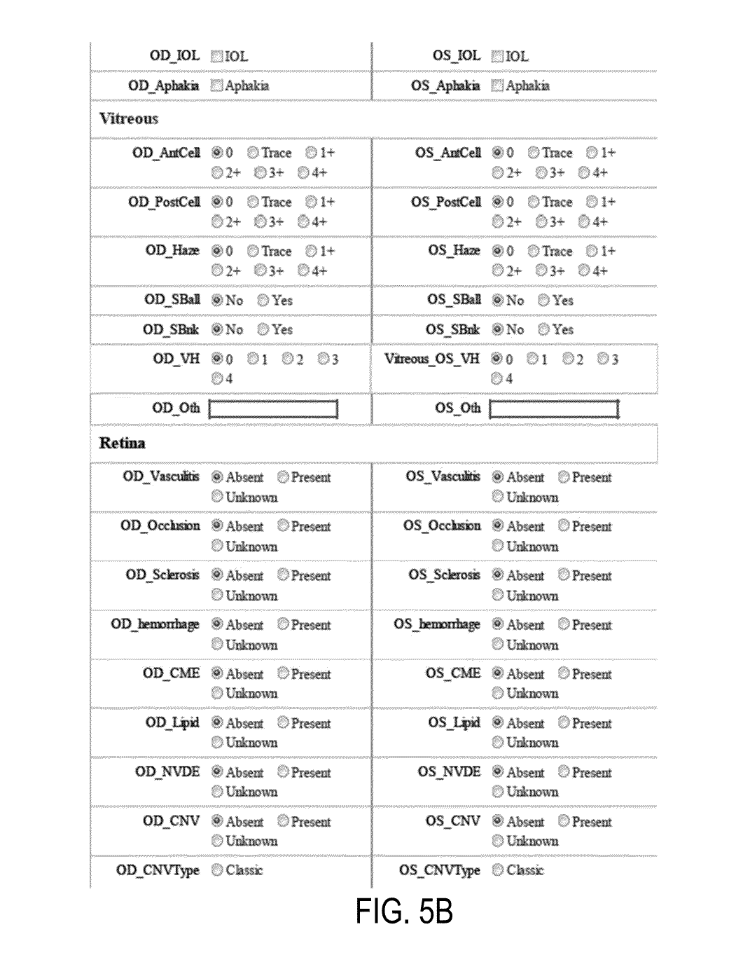

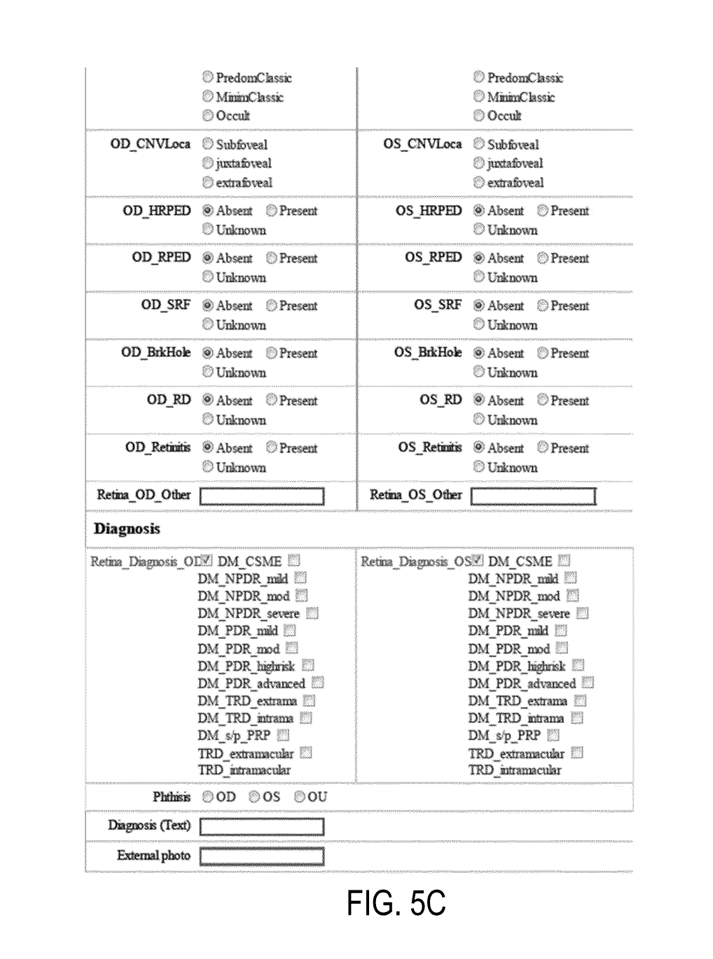

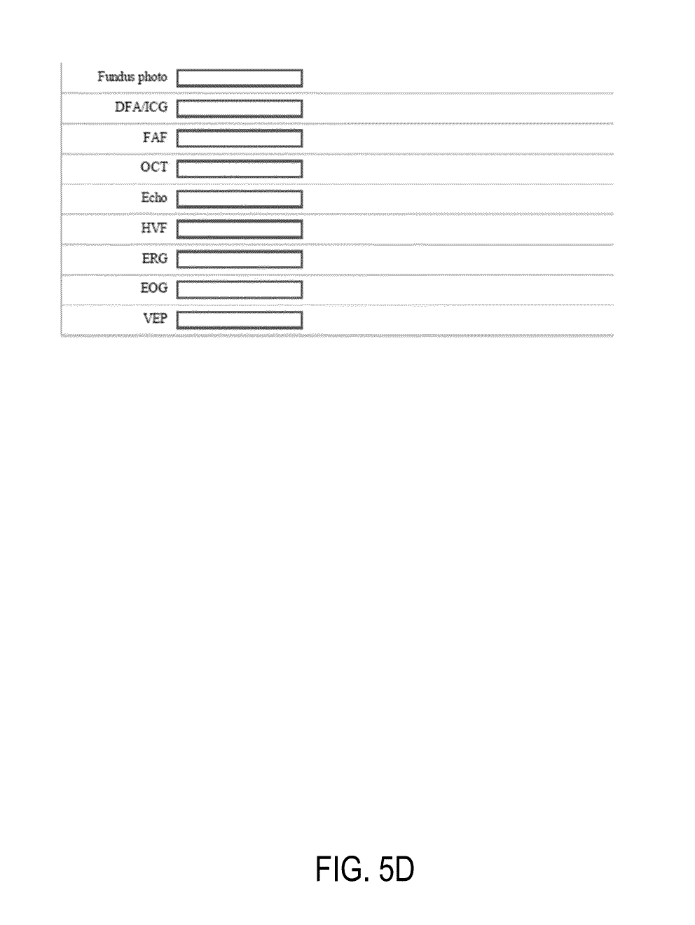

An example of the method according to an embodiment is summarized in the flowchart in FIG. 3, and described below with reference to the system depicted in FIG. 2. First, a user 232 gets access to the web-based portal 212 of the cloud-based system 210 through a user server 230 via a network connection, e.g., the internet 10. The user constructs and inputs a first clinical database protocol using the web-based portal provided by the cloud-based system. The clinical database protocol can include a clinical data template suitable for a clinical study. A first example of the clinical database template is shown in FIGS. 4A-4E, which is used in a clinical study of for uveitis (for ocular inflammation diseases). Another example of the clinical database template is shown in FIGS. 5A-5D, which is used in a clinical study of for retinopathy. It can be seen that the template can be in the form of table that include fields for entering patient information, such as patient ID, height, weight, blood pressure, pulse, symptom complaints, past history, etc. The template can also include clinical measurements and parameters. The web-based portal provides an interface, such as a protocol builder, for the user to design the database template and database template. Depending on the embodiments, the user interface can include graphical user interface, menu-driven options, drag-and-paste operations, etc. In a specific embodiment, the template is stored in a data file in HTML format. However, it is understood that other suitable data format can also be used, for example, Microsoft Excel, Word, etc. Further, the cloud-based system provides the user one or more private databases configured for the primary investigator in a first medical database structure. These private databases include clinical information selected by the user and are organized in the data format and structure specified by the user for the clinical study.

Next, the clinical database protocol is entered into hospital server 240 that is coupled by a network connection 10 to the cloud-based system 210 and is also coupled to a hospital information system (HIS) 250. In the embodiment shown in FIG. 2, the network connection 10 is the Internet. The HIS contains patient medical database 252 arranged in a second medical database structure that is different from first medical database structure. The HIS may be an existing information system server a hospital or multiple hospitals, and may have existing or legacy patient databases. The legacy hospital databases may be arranged in a format and structure to support conventional hospital operation, but may not suitable or efficient for clinical studies or other functions as defined by the user.

In an embodiment, the hospital server 240 is configured to convert patient data between the user's medical database structure and the hospital medical database structures. In order to facilitate the conversion, the user's clinical database protocol can include clinical parameters and designated labels, which correspond to labels in medical records in the hospital information system. For example, the clinical parameters may include one or more of the following entries.
patients taking drug X (labeled as P1 in the HTML table and the hospital database);
patients not taking drug X (labeled as P0 in the HTML table and the hospital database);
the commencement date of drug X (labeled as T0 in the HTML table and the hospital database);
blood pressure before taking drug X (labeled as BP0 in the HTML table and the hospital database); and
blood pressure after taking drug X.

Using the hospital server, the user can enter new patient clinical data in the user's clinical data template using the hospital server. The hospital server is configured to allow the user to enter new clinical data in the new format and stored in the cloud-based private database. In some embodiments, the new data is also entered in the existing database in the hospital information system to maintain continuity in the operation of the hospital information system. In an embodiment, the hospital server enters the new patient clinical data into the user's private database in the cloud-based system according to the user's medical database structure after removing the patient's personal identification information.

In some embodiments, existing patient clinical data from the HIS can be selected and extracted for the clinical study according to a selection criterion in the first protocol using the hospital server. As an example, the selected patient clinical data is entered into the primary investigator's private database in the cloud-based system in the first medical database structure after the patient's personal identification information is removed, so the patient's privacy can be protected. The data in the user's private database can be used for analysis in a clinical study using the web portal provided by the cloud-based system.

In some embodiments, a system is provided for linking a HIS (Hospital Information System) with cloud-based applications. The cloud-based system can include multiple servers, computer programs for supporting cloud services, and application programs for preparing clinical studies, data analysis, graphing, etc. The cloud-based system can also provide each of multiple users with individual private storage space. Merely as an example, an application of such a cloud-based system can be described using the following clinical study scenario.

1. A primary investigator (PI) access a protocol form builder on the cloud via a website to define a protocol form, which is in HTML;
2. The PI accesses HIS, inputs the protocol form to HIS. A preprocessor in the hospital server converts the form to an internal form for accessing the HIS database;
3. The PI can input new patient data into HIS using his protocol form. The preprocessor checks to see if old data exists for this patient. The preprocessor collects all data, delinks the data (remove patient identification information for privacy concerns), then outputs all data related to this patient to PI's private database storage space on the cloud. The patient data is stored in the cloud in the format (protocol) specified by the PI without personal identification information. In some embodiment, the HIS database is updated according to old HIS format;
4. The PI can carry out data analysis on the cloud for clinical study.

In the system described above, the PI can define a different protocol for a different a clinical study of a different disease. The PI can also share data from different PI's. The cloud can also include provisions for security, authentication, etc.

In embodiments of the invention, an interface is provided to link the user's data template and protocol to the database in the hospital information system. In an embodiment, each clinical parameter stored in the hospital database is labeled with a specific code. For example, patient's blood pressure is labeled as 123, white cell count is labeled as 456, renal function test is labeled as 789, surgical treatment is labeled as xyz, patient taking drug x is labeled as X1, patient not taking drug X is labeled X0. Other clinical information, such as how long a cataract surgery takes, can also be extrapolated from data in the database, e.g., by labeling surgery commencement time as T1 and surgery ending time as T2 in the hospital database.

In embodiments of the invention, the form builder has an items bank, which can offer the PI an easier way to make a new form by choosing the items. Each item has its localization code in the HIS system, which allows the pre-set template to get the data from the HIS for each item. For example, visual acuity (VA) and intraocular pressure (IOP) are two common items for each study project in ophthalmology and for each visit of each patient. The VA and IOP have their localization code in the HIS. So, in the form builder, each new form can select the VA item and the IOP item from the item-bank. When the new form is sent into the HIS via the internet portal, the localization code of each item can be used to request the new value of VA and IOP from the HIS and fill the item automatically. Then, the new form filled with new values can be sent out to the cloud database for further computations. The items bank with the localization codes in the form builder can offer the principle investigator a new and easy way to build new forms with auto-function of data collection from the HIS. Furthermore, with the items bank with localization code, no modification of each hospital's HIS is necessary before the merge of data tables in multicenter study.

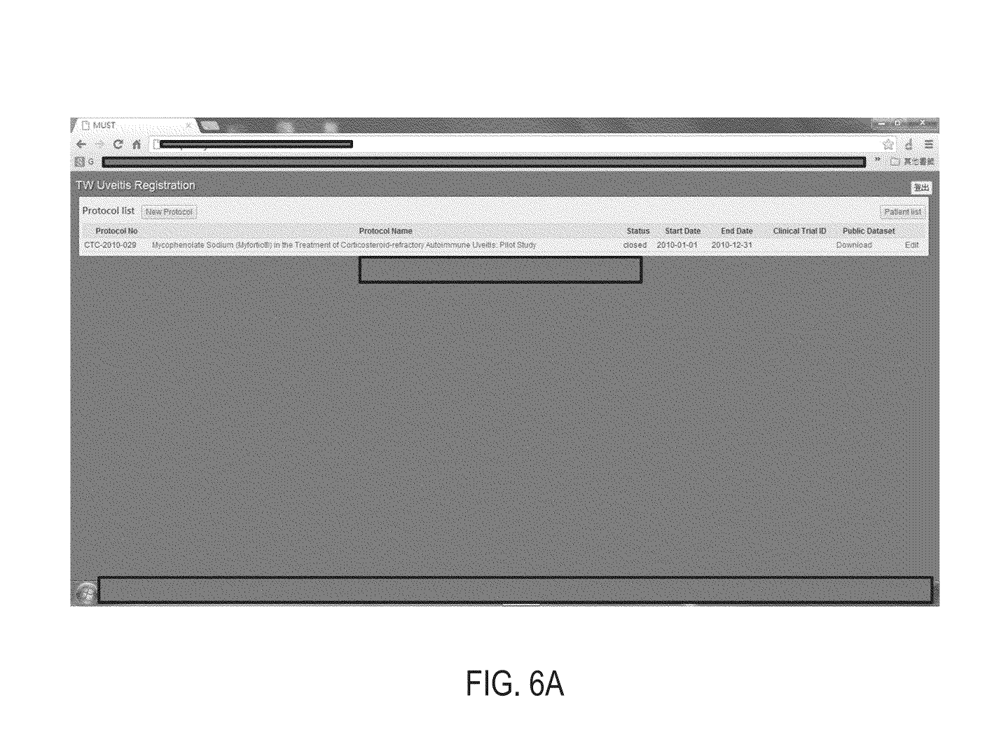

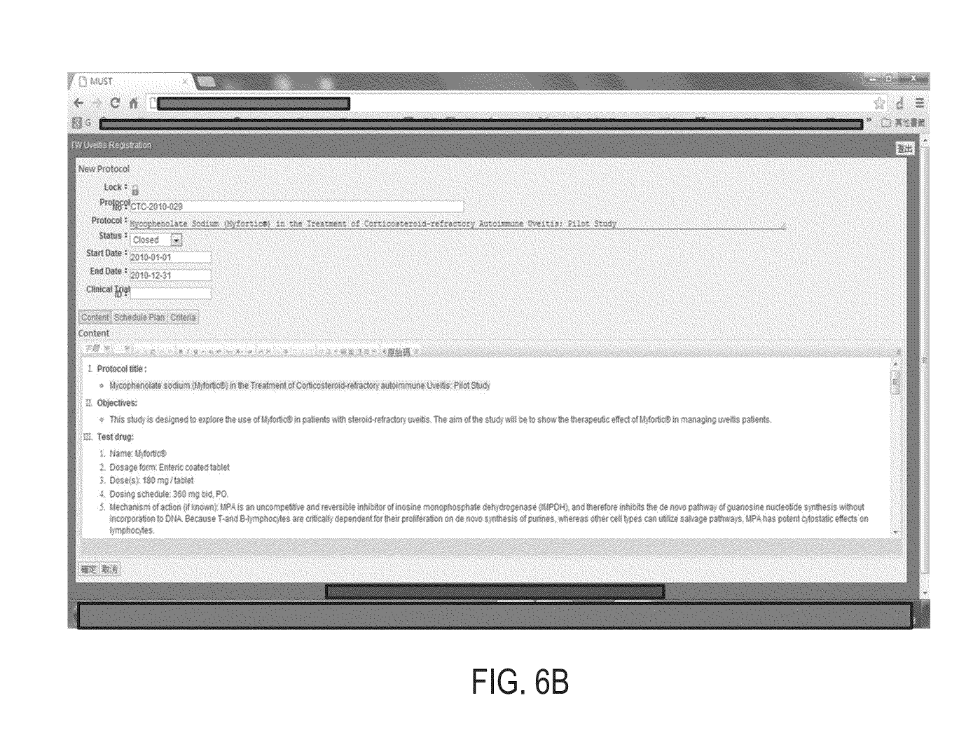

In some embodiments, the cloud-based system provides a protocol builder, in which a user, e.g., a health care provider, initiates a clinical study protocol and defines one or more clinical parameters to be included in the clinical study protocol. FIG. 6A illustrates a screenshot of the protocol builder for initiating a new clinical study protocol, and FIG. 6B illustrates a screenshot of a completed protocol using the protocol builder in the cloud-based system. The user can access the cloud-based system through any web browser, such as Internet Explorer, Google Chrome, or Mozilla Firefox, and from any electronic device, such as a laptop, a tablet, or a mobile communication device.

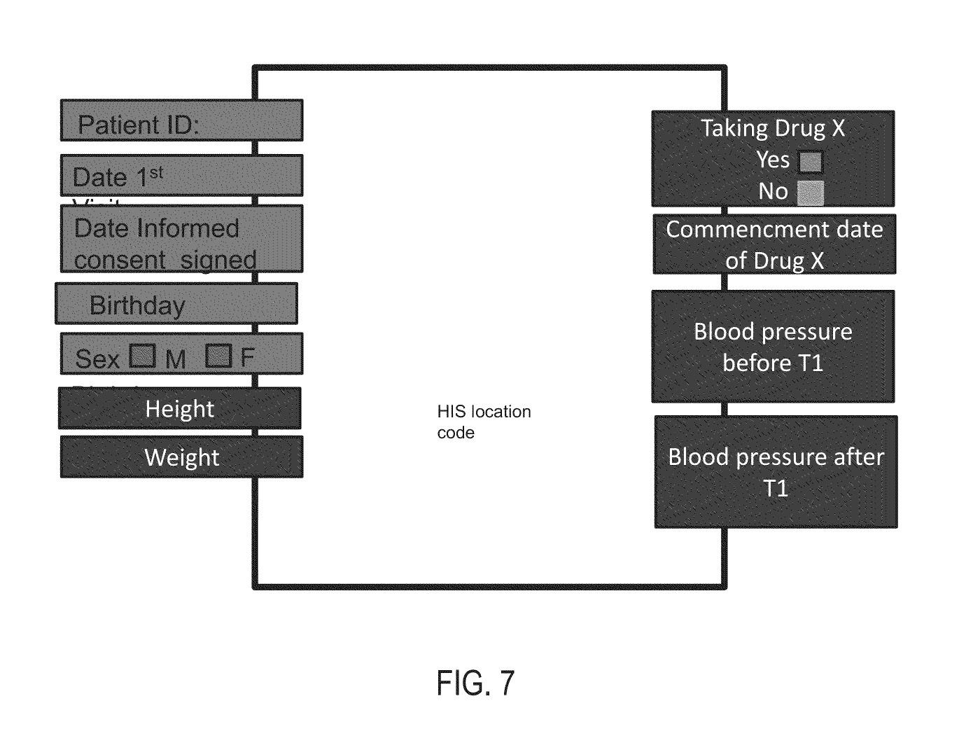

As an example, a primary investigator initiates a clinical protocol in the cloud-based system to examine the effect of drug X on patient's blood pressure. FIG. 7 illustrates an example of parameter selection menu provided by the protocol builder. The clinical parameters can be selected and dragged to the protocol. In this case, the primary investigator identifies and selects relevant clinical parameters in the protocol builder, such as patients taking drug X, patients not taking drug X, the commencement date of drug X, blood pressure before taking drug X, and blood pressure after taking drug X, etc.

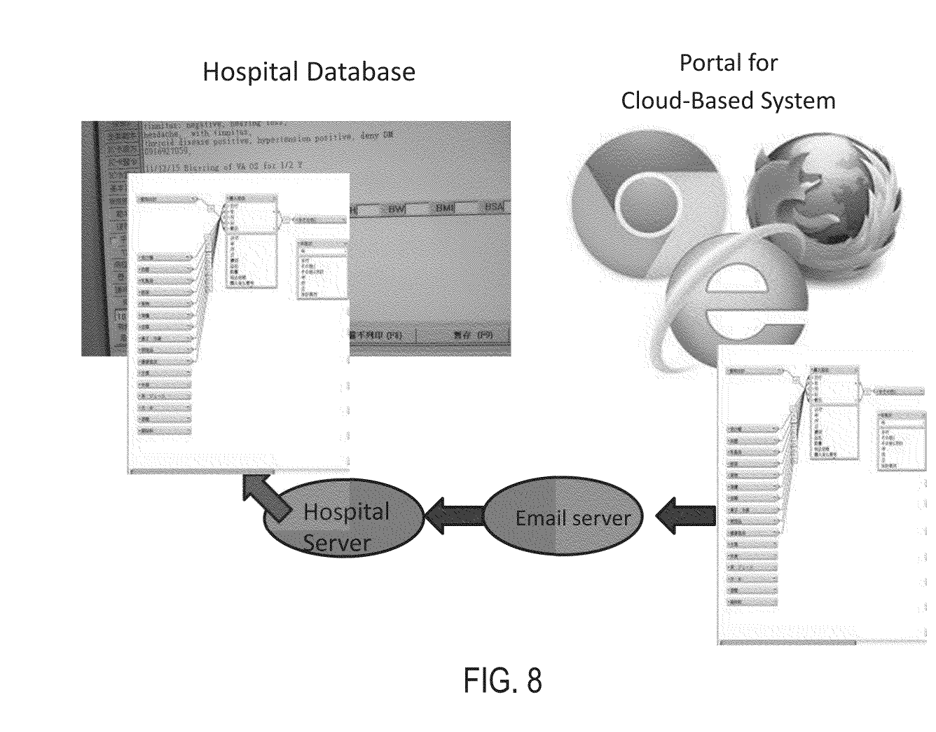

FIG. 8 is a diagram illustrating an example of process flow in which the completed protocol constructed in cloud-based system is presented to the hospital information system, which includes the hospital database. In one embodiment, the protocol builder generates a template in an HTML language-based table that includes the clinical parameters in the newly generated protocol. The HTML language table can contain the clinical parameters and designated labels, which correspond to the hospital database labels. For example, the HTML language table can include the following parameters and labels: patients taking drug X (labeled as P1 in the HTML table and the hospital database), patients not taking drug X (labeled as P0 in the HTML table and the hospital database), the commencement date of drug X (labeled as T0 in the HTML table and the hospital database), blood pressure before taking drug X (labeled as BP0 in the HTML table and the hospital database), and blood pressure after taking drug X (labeled as BP1 in the HTML table and the hospital database), etc.

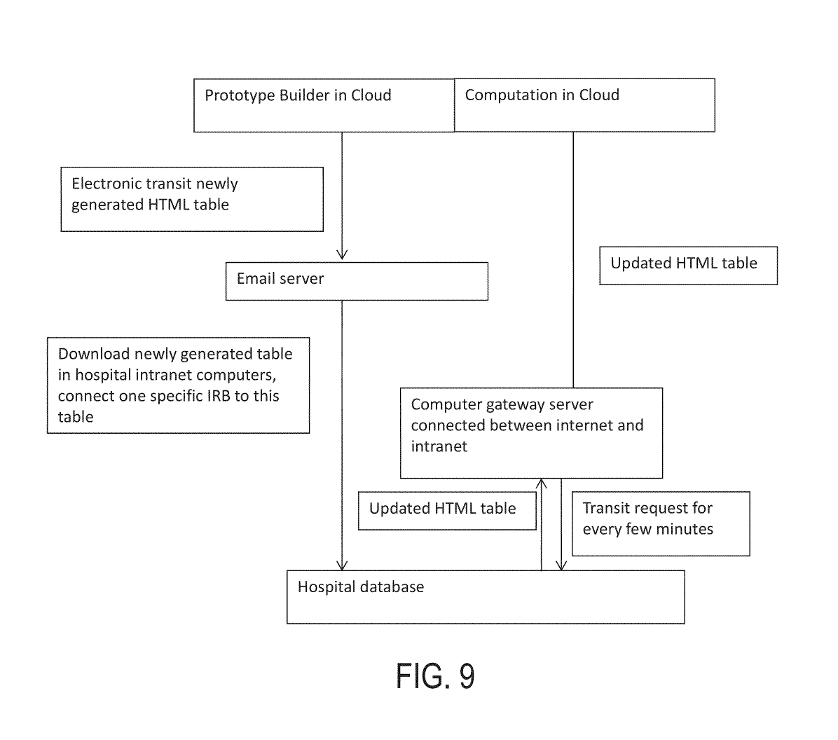

FIG. 9 is a system diagram and flowchart showing the operation of the database management system according to an embodiment of the present invention. First, an HTML table is generated by the protocol builder in the cloud-based system electronically transmitted to the user's email account in an email server. The HTML is then presented to the hospital database. In an embodiment, the user downloads the newly generated table in hospital intranet computers, which connect one specific IRB to this table and presents the table to the hospital database. In another embodiment, the user presents HTML table to the hospital-based computer server, which has privileged access to the hospital database for identifying and extracting the relevant clinical data. In an example, the user can download the HTML table to a portable computer storage medium, such as a disc or a flash drive, and uploads the table to the hospital server. This process ensures strict control of the access to the hospital database. Alternatively, the protocol table can be transferred to the hospital server electronically, but with the user's authorization. The hospital server or a hospital intranet computer is configured to extract clinical data from the hospital database with labels matching to those in the HTML table, and transmits the extracted data to the user's database in the cloud-based system. In some embodiments, a computer gateway server is used to connect between the internet and the hospital intranet. The hospital server is also configured for the user to enter new clinical data. In some embodiments, the hospital server regularly executes the request according to the HTML table to update the data. For example, the hospital server can extract the clinical data with the following labels: P1, PO, T0, BP0 and BP1 on a regular basis. In some embodiments, a request for update is sent to the hospital database once every few minutes. The updated HTML table can be analyzed in using computational resources in the cloud-based system.

In some embodiments, the hospital server acts as a gateway for the hospital database for transmitting requests to and receiving data from the hospital database. In one embodiment, the hospital server access the data from the hospital database according to the method disclosed in U.S. Pub. No. 2012/0203817, which is incorporated herein by reference in its entirety.

The extracted clinical data is subsequently transmitted from the hospital server back to the cloud-based system for storage and analysis. The cloud-based system provides analytical tools for the user to perform the analyses needed for a clinical study. In some embodiments, the user-defined protocol can include analyses to be performed. In this case, the cloud-based system can automatically perform immediate statistical analysis of the extracted data. The analysis can include but is not limited to the mean, the median, the 95% confidence interval, survival analysis, or multivariate analysis, etc.

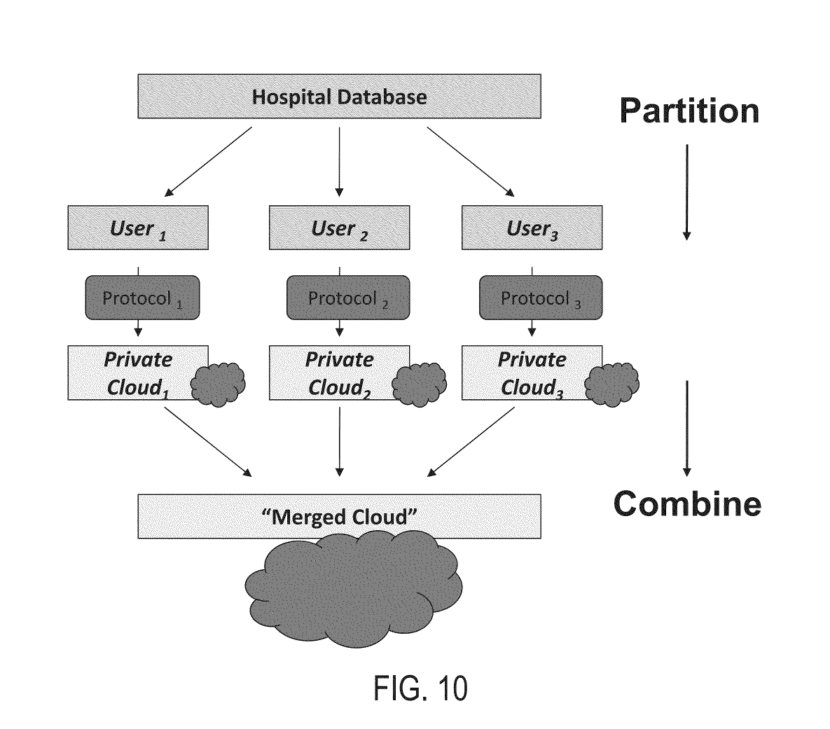

FIG. 10 is a system diagram illustrating a merged cloud-based system according to some embodiments of the present invention. As shown in FIG. 10, each private cloud is a cloud-based system that provides each user or health care provider a separate private data base on the cloud-based system. The cloud-based system is configured to allow the user to access different private databases for analysis. In alternative embodiments, the data for each user is stored in a separate cloud-based system. The merged cloud is a cloud-based system is configured to allow the different private databases on different cloud-based systems to be merged, which can be used, for example, in a multicenter clinical trial or analysis. As shown in the example of FIG. 10, users 1, 2, and 3 are the principal investigators of a multicenter clinical trial. Each principle investigator has created his or her own clinical protocol (protocols 1 to 3) through a separate cloud-based system. The data extracted from the hospital database is stored in each principle investigator's private cloud-based system (private clouds 1 to 3). Ultimately, the data from each private cloud can be combined into a merged cloud in the multi-center clinical trial.

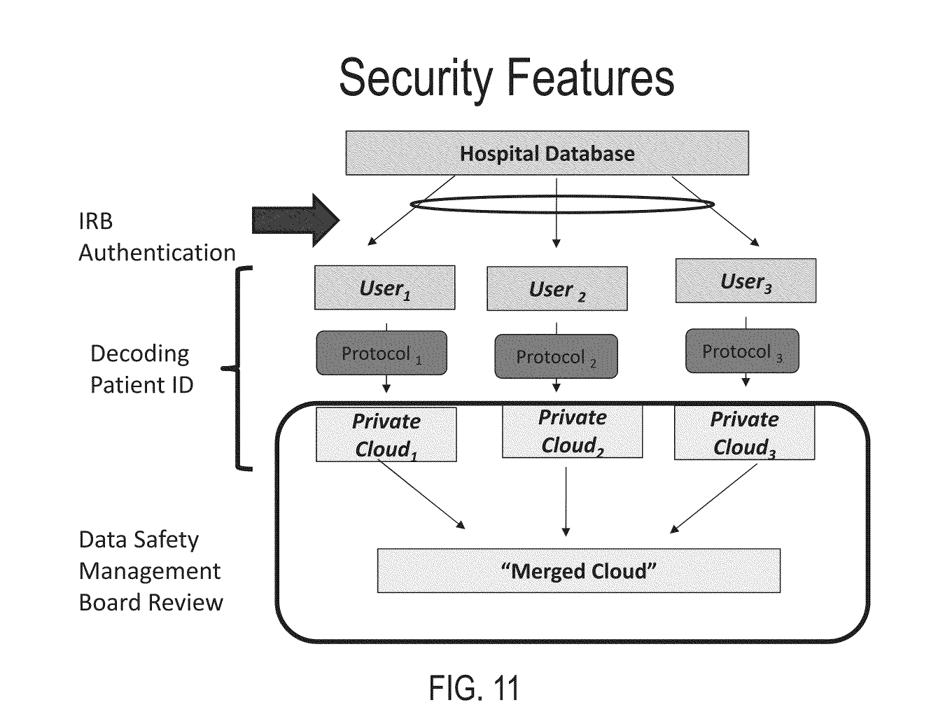

In some embodiments, security features can be incorporated into the system to protect patient's privacy and data security, as illustrated in FIG. 11. In one embodiment, the security feature can include the authentication of Institution Review Board (IRB) approval. The hospital database determines whether Institution Review Board approval was issued before releasing the clinical data to the hospital server. In another embodiment, the security feature includes the decoding of patient's identification. This can be done by presenting patient's identification as scramble code in the updated HTML table. In yet another embodiment, the hospital data safety management board can access the cloud-based system to determine if the extracted data exceeds the scope of IRB approval. In some embodiments, the system also includes security features described in the disclosure in U.S. Pat. No. 7,822,976, which is incorporate by reference in its entirety.

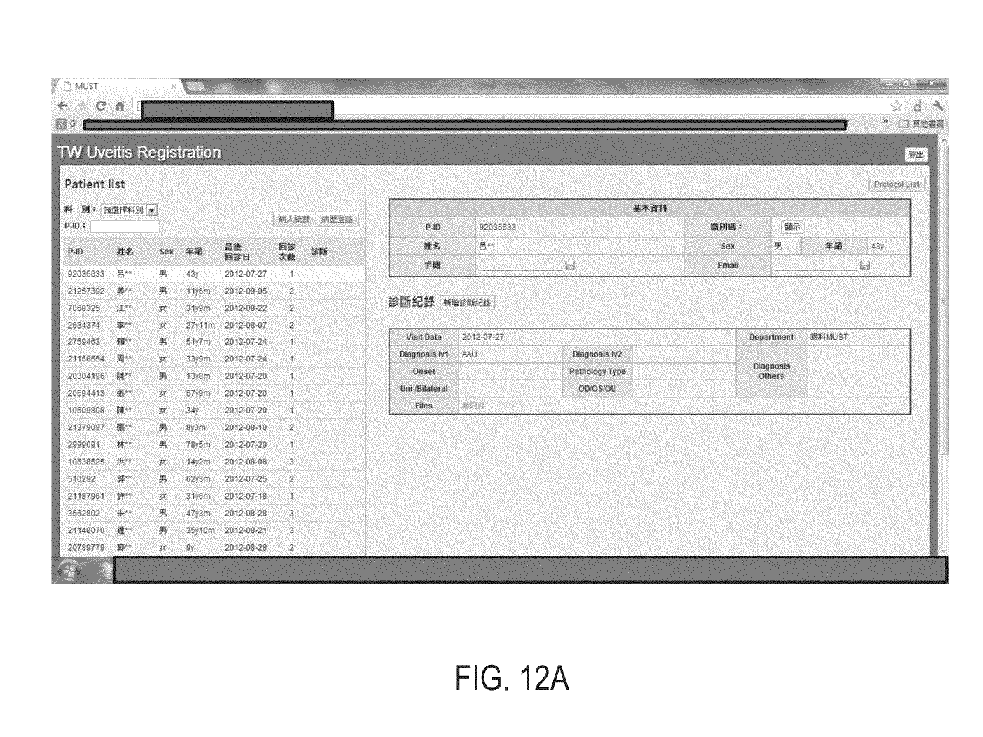

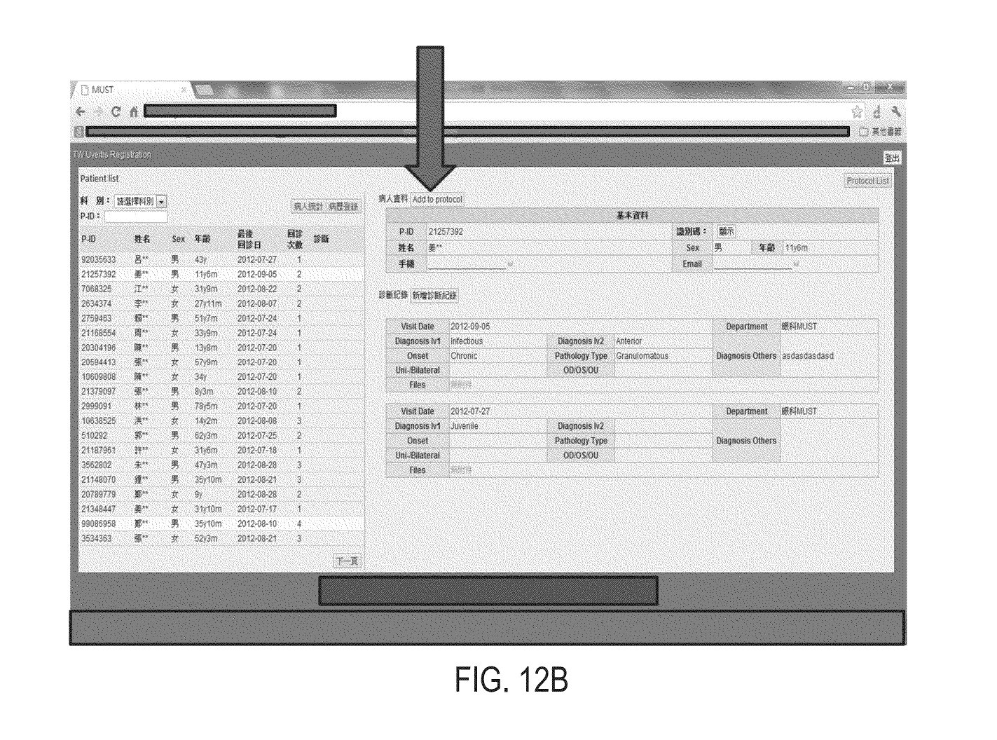

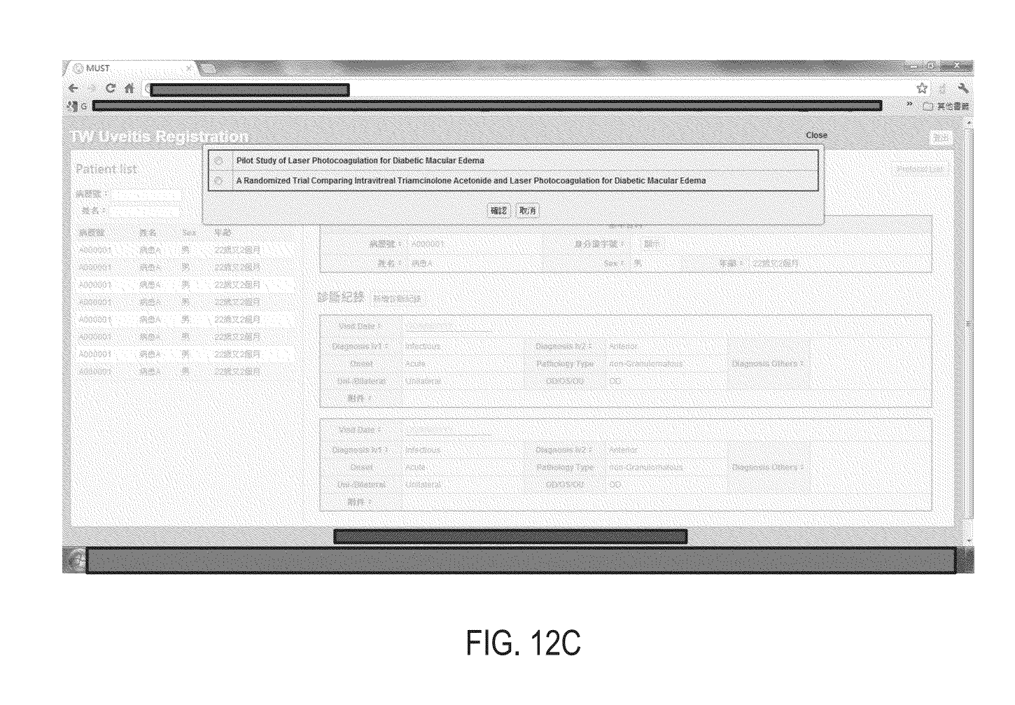

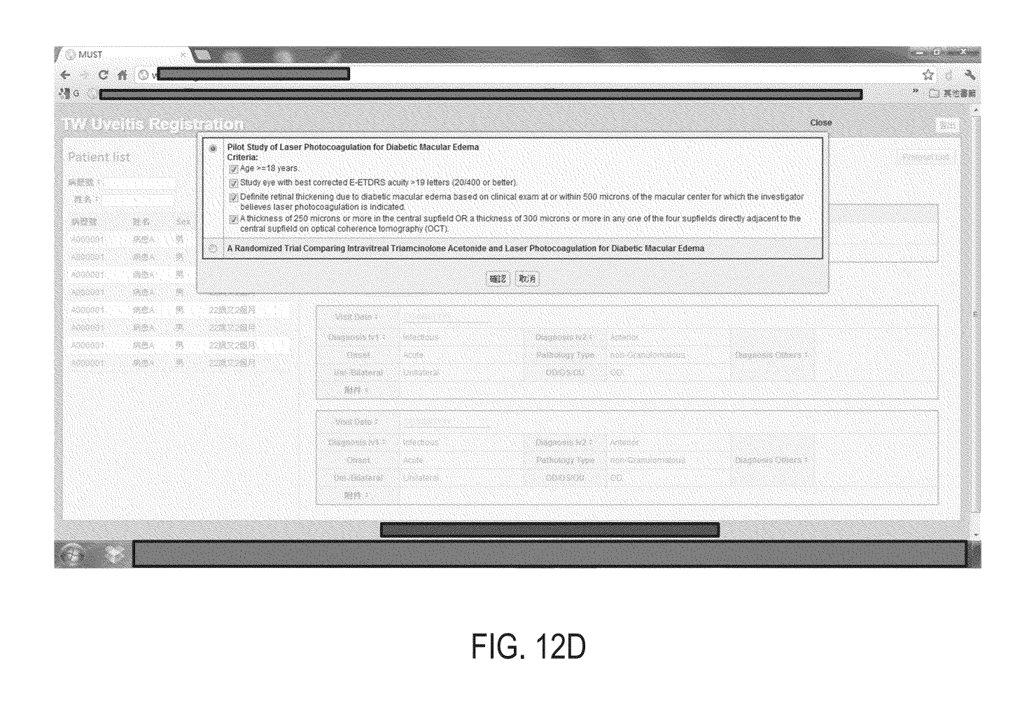

FIG. 12A to FIG. 12D are screenshots showing the steps to enroll a new patient into a clinical protocol in the cloud-based system according to an embodiment of the present invention. In some embodiments, a newly recruited patient can be added to an existing clinical study protocol. As shown in FIG. 12A to FIG. 12D, the health care provider highlights the patient to be added into the existing protocol (FIG. 12A), and clicks on the “Add to Protocol” button (FIG. 12B). A list of protocols is shown in the next screenshot (FIG. 12C), allowing the health care provider to register the new patient into a specific protocol. Once the protocol is selected, a brief description of the protocol is shown in the next screenshot (FIG. 12D) before the health care provider confirms the registration of the patient into the selected protocol.

While certain embodiments of the invention have been illustrated and described, those skilled in the art with access to the present teachings will recognize that the invention is not limited to these embodiments only. Accordingly, it is to be understood that the invention is intended to cover numerous modifications, changes, variations, substitutions, and equivalents that will be apparent to those skilled in the art.

What is claimed is:

1. In a cloud-based system, a method for a user to manage patient clinical database, the method comprising:
providing a first clinical database protocol that includes a first clinical data template suitable for a clinical study using a web-based portal provided by a cloud-based system, the cloud-based system including a private database configured for the primary investigator in a first medical database structure;
entering the first clinical database protocol into a hospital server that is coupled by a network connection to the cloud-based system and is also coupled to a hospital information system (HIS), wherein the HIS contains patient medical data arranged in a second medical database structure that is different from first medical database structure; and
performing one or more of the following:
(i) entering new patient clinical data in the first clinical data template using the hospital server, wherein the hospital server enters the new patient clinical data into the user's private database in the cloud-based system according to the first medical database structure after removing the patient's personal identification information, wherein the new patient clinical data is entered into the HIS according to the second medical database structures; and
(ii) extracting existing patient clinical data from the HIS for the clinical study according to a selection criterion in the first protocol using the hospital server, wherein the selected patient clinical data is entered into the user's private database in the cloud-based system in the first medical database structure after the patient's personal identification information is removed; and
performing the clinical study using data in the user's private database using the web-based portal provided by the cloud-based system.

2. The method of claim 1, wherein the cloud-based system comprises:
a storage medium;
one or more processors coupled to said storage medium; and
an interface to a network.

3. The method of claim 1, wherein the hospital server comprises:
a storage medium;
one or more processors coupled to said storage medium; and
an interface to a network.

4. The method of claim 1, wherein entering the first medical data protocol into the hospital server comprises the user transferring the first medical data protocol into the hospital server offline using a portable computer storage medium.

5. The method of claim 4, wherein the portable computer storage medium comprises a computer disc or a flash drive.

6. The method of claim 4, further comprising the user receiving the protocol via an email sent by the cloud system.

7. The method of claim 1, wherein entering the first clinical database protocol into the hospital server comprises the user personally authorizing an on-line transfer.

8. The method of claim 1, wherein the first clinical database protocol comprises an HTML table.

9. The method of claim 1, wherein the first clinical database protocol comprises clinical parameters and designated labels, which correspond to labels in medical records in the hospital information system.

10. The method of claim 9, wherein the clinical parameters comprises one or more of:
patients taking drug X (labeled as P1 in the HTML table and the hospital database);
patients not taking drug X (labeled as P0 in the HTML table and the hospital database);
the commencement date of drug X (labeled as T0 in the HTML table and the hospital database);
blood pressure before taking drug X (labeled as BP0 in the HTML table and the hospital database); and
blood pressure after taking drug X.

11. The method of claim 1, wherein the clinical study comprises performing data analysis to determine one or more of the mean, the median, the 95% confidence interval, survival correlations, or multivariate relationships.

12. The method of claim 1, further comprising the cloud-based system automatically updating the private database if the hospital server receives new clinical data that satisfied the selection criterion in the first protocol.

13. The method of claim 1, further comprising accessing a second private database of a second user in the cloud-based system to be included in the clinical study.

14. The method of claim 1, further comprising accessing a second cloud-based system to be included in the clinical study.

15. The method of claim 1, further comprising obtaining Institution Review Board (IRB) approval before the HIS releasing clinical data to the hospital server.

16. The method of claim 1, further including the cloud-based system providing a hospital data safety management board access to the cloud-based system to determine if the extracted data exceeds the scope of Institution Review Board (IRB) approval.

17. The method of claim 1, further comprising including encoded patient identification in the clinical data in the user's private database.

18. A method for a user to manage a private database in a cloud-based system, the method comprising:
specifying a first database protocol that includes a first data template for a first database structure using a web-based portal provided by the cloud-based system, the cloud-based system including a first database for the user containing data in the first database structure;
entering the first database protocol into a server that is coupled to a second database system that contains data arranged in a second database structure that is different from first database structure, the server being coupled to the cloud-based system by a network connection; and
entering new data into the server according to the first data template, wherein the server enters the new data into the first database in the cloud-based system according the first database protocol, and the server enters the new data into the second database according to the second database structure;
selecting data from the second database according to a selection criterion in the first protocol using the server, wherein the server enters the selected data into the first database in the cloud-based system in the first database structure according to the first database template; and
analyzing data in the first database using the web-based portal provided by the cloud-based system.

19. A method for managing a private database in a cloud-based system, the method comprising:
providing a first database protocol that includes a first data template for a first database structure for a first database provided by a cloud-based system;
entering new data according to the first data template, wherein the new data is entered into the first database in the cloud-based system according the first database protocol, and the new data is into the second database according to a second database structure that is different from first database structure;
extracting data from the second database according to a selection criterion in the first protocol, wherein the extract data is entered into the first database in the cloud-based system in the first database structure according to the first database template, and
analyzing the data in the first database using the web-based portal provided by cloud-based system.

20. A system for database management, comprising:
a cloud-based system having a storage medium, one or more processors coupled to said storage medium, an interface to a network, and computer code stored in said storage medium wherein said computer code, when retrieved from said storage medium and executed by said one or more processor, results in:
providing a web portal for a user;
receiving user input for constructing a first database protocol that includes a first data template for a first database structure for a first database provided by the cloud-based system;
receiving data from the network and storing the received data in the first database; and
receiving user command for data analysis;
and
a server having a storage medium, one or more processors coupled to said storage medium, and computer code stored in said storage medium, the server coupled to a second database, the server also coupled to the cloud-based system through the network, wherein said computer code, when retrieved from said storage medium and executed by said one or more processor, results in:
receiving first database protocol that includes the first data template;
receiving new data according to the first data template;
storing the new data is into the second database according to a second database structure that is different from first database structure;
extracting data from the second database according to a selection criterion in the first protocol; and
entering data into the first database in the cloud-based system according the first database protocol.
